(19) United States
(12) Patent Application Publication
(10) Pub. No.: US 2011/0231276 A1
(43) Pub. Date: Sep. 22, 2011

(54) METHODS FOR ACCESSING PAYABLE CONTENT USING SOCIAL NETWORKS

(76) Inventors: Tet Hin Yeap, Ottawa (CA); Thomas Anton Goeller, Grafing (DE); Wei Du, Nepean (CA)

(21) Appl. No.: 13/034,159

(22) Filed: Feb. 24, 2011

Related U.S. Application Data
(60) Provisional application No. 61/314,844, filed on Mar. 17, 2010.
(60) Provisional application No. 61/369,129, filed on Jul. 30, 2010.

(51) Int. Cl. G06Q 30/00

(52) U.S. Cl. 705/26.3; 705/27.1

(57) ABSTRACT

A social network server executes instructions to implement a method that comprises: establishing a connection to a payable content management server that stores a set of preview items corresponding to payable content items and a location element for each payable content item; rendering the preview items accessible to a computing appliance connected to the social network server; receiving an indication that a particular one of the preview items has been selected using the computing appliance; and forwarding to the computing appliance the location element for the payable content item corresponding to the selected preview item. The location element for the payable content item corresponding to the selected preview item comprises an address of (or a domain name routable to) a designated network entity operated by an organization with which an operator of the payable content management server or the payable content item server has an inter-organizational billing arrangement.

### CROSS-REFERENCE TO RELATED APPLICATIONS

The present application claims the benefit under 35 USC §119(e) of U.S. Provisional Patent Application Ser. No. 61/314,844, filed Mar. 17, 2010 and U.S. Provisional Patent Application Ser. No. 61/369,129, filed Jul. 30, 2010, both of which are hereby incorporated by reference herein.

### BACKGROUND

A social network is a set of social actors such as people connected by a set of social relationships such as friendship or common interest. A well known example of a service with applicability to social networks (i.e., a “social network service”) is FaceBook. FaceBook's members can create profiles with photos, lists of personal interests, contact information and other personal information. Communicating with friends and other members can be done through private or public messages or a chat feature. Members can add friends and send them messages, and update their personal profiles to notify friends about themselves.

However, what is lacking from today's social network services such as FaceBook is a way for members to buy and sell user-generated content in a simple and secure manner.

### SUMMARY

According to a broad aspect, the present invention seeks to provide a non-transitory computer-readable storage medium storing computer-readable instructions for execution by a social network server, wherein execution of the instructions causes the social network server to implement a method that comprises: establishing a connection to a payable content management server that stores a set of preview items corresponding to payable content items and a location element for each payable content item; rendering the preview items accessible to a computing appliance connected to the social network server; receiving an indication that a particular one of the preview items has been selected using the computing appliance; and forwarding to the computing appliance the location element for the payable content item corresponding to the selected preview item.

According to another broad aspect, the present invention seeks to provide a method for execution by a social network server, comprising: establishing a connection to a payable content management server that stores a set of preview items corresponding to payable content items and a location element for each payable content item; rendering the preview items accessible to a computing appliance connected to the social network server; receiving an indication that a particular one of the preview items has been selected using the computing appliance; and forwarding to the computing appliance the location element for the payable content item corresponding to the selected preview item.

According to a further broad aspect, the present invention seeks to provide a method comprising: logging into a social network service using member credentials; accessing a profile page of an other member of the social network service; triggering instantiation of an e-commerce application represented on the profile page of the other member of the social network service; viewing through the e-commerce application a set of preview items associated with payable content items offered for sale by the other member of the social network service; selecting via the e-commerce application one of the preview items associated with a desired payable content item; and receiving a location element for the desired payable content item.

According to yet another broad aspect, the present invention seeks to provide a non-transitory computer-readable storage medium storing computer-readable instructions for execution by a computer, wherein execution of the instructions causes the computing appliance to implement a method that comprises: submitting member credentials for logging into a social network service; displaying a profile page of an other member of the social network service; triggering instantiation of an e-commerce application represented on the profile page of the other member of the social network service; displaying via the e-commerce application a set of preview items associated with payable content items offered for sale by the other member of the social network service; submitting via the e-commerce application user selection of one of the preview items associated with a desired payable content item; and receiving a location element for the desired payable content item.

According to yet a further broad aspect, the present invention seeks to provide a non-transitory computer-readable storage medium storing computer-readable instructions for execution by a server, wherein execution of the instructions causes the server to implement a method that comprises: displaying via a graphical user interface a profile page of a particular member of a social network service, the profile page maintaining information about the particular member accessible to other members of the social network service, wherein the information maintained on the profile page of the particular member includes an actionable link; responding to actioning of the link by a visiting member of the social network service by: establishing a connection to a payable content management server that stores a set of preview items corresponding to payable content items and a location element for each payable content item; rendering the preview items accessible to the visiting member; receiving an indication that a particular one of the preview items has been selected by the visiting member; and forwarding to the visiting member the location element for the payable content item corresponding to the selected preview item.

According to still another broad aspect, the present invention seeks to provide a method, comprising: displaying via a graphical user interface a profile page for a particular member of a social network service, the profile page maintaining information about the particular member accessible to other members of the social network service, wherein the information maintained on the profile page of the particular member includes an actionable link; responding to actioning of the link by a visiting member of the social network service by: establishing a connection to a payable content management server that stores a set of preview items corresponding to payable content items and a location element for each payable content item; rendering the preview items accessible to the visiting member; receiving an indication that a particular one of the preview items has been selected by the visiting member; and forwarding to the visiting member the location element for the payable content item corresponding to the selected preview.

According to yet another broad aspect, the present invention seeks to provide a non-transitory computer-readable storage medium storing computer-readable instructions for execution by a server, wherein execution of the instructions causes the server to implement a method that comprises: authorizing a user of a computing appliance to access a social network service based upon credentials of a member of the social network service; receiving from the computing appliance a payable content item, a preview item corresponding to the payable content item and a price at which the payable content item is to be sold to other members of the social network; establishing a connection to a payable content management server; and providing to the payable content management server the payable content item, the preview item, the price and an identification of an account maintained by the payable content management server.

According to another broad aspect, the present invention seeks to provide a method, comprising: authorizing a user of a computing appliance to access a social network service based upon credentials of a member of the social network service; receiving from the computing appliance a payable content item, a preview item corresponding to the payable content item and a price at which the payable content item is to be sold to other members of the social network; establishing a connection to a payable content management server; and providing to the payable content management server the payable content item, the preview item, the price and an identification of an account maintained by the payable content management server.

According to still another broad aspect, the present invention seeks to provide a method of enabling updates to a set of payable content items offered for sale by a member of a social network service through an e-commerce application accessible to other members of the social network service, comprising: receiving from a server associated with the social network service (i) an indication of the member; (ii) a payable content item and (iii) a preview item corresponding to the payable content item; causing the payable content item to be stored in a remote location attributed to the member; storing, in a local location attributed to the member, the preview item and a location element for the payable content item.

According to yet another broad aspect, the present invention seeks to provide a payable content item server, comprising: an input for receiving from a server associated with a social network service (i) an indication of a member of the social network service; (ii) a payable content item and (iii) a preview item corresponding to the payable content item; an output for releasing the payable content item to towards a remote location attributed to the member; a memory for storing, in association with the member, the preview item and a location element for the payable content item.

For example, a specific non-limiting embodiment allows a user of a social network service (such as FaceBook) who wishes to sell a content item (e.g., a recipe, a music recording, a picture, etc.) to upload the content item to a directory reserved for that user on a payable content item server and to use the ability of a web plug-in (such as an Adobe Flash-based application) in order to display a thumbnail stored on a payable content management server with a link pointing to the content item in a new profile tab created in the user's social network profile. The payable content item server charges purchasers of the payable content item through multiparty billing of telecommunications services.

The above embodiment has specific application to the case where, in order to avoid security problems such as phishing, social network services prohibit members' application software from creating a web link directly pointing to a file located in an external server not approved by the social network service.

According to another broad aspect, the present invention seeks to provide a method, comprising: maintaining in a directory associated with a first user of a social network service (i) a preview item corresponding to a payable content item stored on a payable content item server and (ii) a location element for the payable content item, the preview item being displayable to other users of the social network service when the other users activate an e-commerce application via a social network profile of the first user; collecting bids on the payable content item from a plurality of bidders who are other users of the social network service; determining a winning bid and a winning bidder; and transmitting the location element to the winning bidder.

According to a further broad aspect, the present invention seeks to provide a bidding server, comprising: a memory for maintaining in a directory associated with a first user of a social network service (i) a preview item corresponding to a payable content item stored on a payable content item server and (ii) a location element for the payable content item, the preview item being displayable to other users of the social network service when the other users activate an e-commerce application via a social network profile of the first user; an input for collecting bids on the payable content item from a plurality of bidders who are other users of the social network service; a processing entity for determining a winning bid and a winning bidder; and an output for transmitting the location element to the winning bidder.

According to a still further broad aspect, the present invention seeks to provide a non-transitory computer-readable storage medium storing computer-readable instructions for execution by a server that maintains in a directory associated with a first user of a social network service (i) a preview item corresponding to a payable content item stored on a payable content item server and (ii) a location element for the payable content item, the preview item being displayable to other users of the social network service when the other users activate an e-commerce application via a social network profile of the first user, wherein execution of the instructions causes the computing appliance to implement a method that comprises: collecting bids on the payable content item from a plurality of bidders who are other users of the social network service; determining a winning bid and a winning bidder; and transmitting the location element to the winning bidder.

For example, a specific non-limiting embodiment allows a user of a social network service (such as FaceBook) who wishes to auction off a content item to upload the content item to a directory reserved for the user on a payable content item server and to use the ability of a web plug-in (such as an Adobe Flash-based application) in order to display a thumbnail stored on a bidding server with a link pointing to the content item in a new profile tab created in the user's social network profile. Thus, a group of the user's friends can examine the displayed thumbnail in the user's profile tab, bid for the content item over the internet at any time over a specified period. The bidding server determines the winning bid, following which the winning bidder is charged using multiparty billing of telecommunications services.

### BRIEF DESCRIPTION OF THE DRAWINGS

Embodiments of the invention will now be described by way of example only, and with reference to the accompanying drawings, in which:

FIGS. 1A and 1B show a block diagram of a multiparty billing architecture in accordance with a specific non-limiting embodiment;

FIG. 2 shows an address bar for entry of a URL associated with an e-commerce application configurable via a social network service, in accordance with a non-limiting embodiment;

FIG. 3 shows a menu page from which settings regarding the e-commerce application can be configured by a store owner using the social network service, in accordance with a non-limiting embodiment;

FIG. 4 shows a page listing applications visited by a store owner, including the e-commerce application, in accordance with a non-limiting embodiment;

FIG. 5 shows a configuration page used in the configuration of the e-commerce application, in accordance with a non-limiting embodiment;

FIG. 6 shows the appearance of a tab associated with the e-commerce application in a social network profile page of the store owner, in accordance with a non-limiting embodiment;

FIG. 7 shows a page indicating that the e-commerce application has successfully passed an installation stage, in accordance with a non-limiting embodiment;

FIG. 8 shows a navigation bar associated with the e-commerce application once it has been successfully configured, including a home button and an admin button, the admin button associated with an administration component of the e-commerce application, in accordance with a non-limiting embodiment;

FIG. 9 shows a window seeking credentials of the store owner to allow binding of the e-commerce application to a payable content management server where information regarding payable content items is stored on behalf of the store owner, in accordance with a non-limiting embodiment;

FIG. 10 shows an admin window in which is portrayed a thumbnail corresponding to a payable content item offered for sale by the store owner by means of the e-commerce application, in accordance with a non-limiting embodiment;

FIG. 11 provides illustrates a plurality of buttons that can be used by the store owner to add or update the payable content items offered for sale by means of the e-commerce application, in accordance with a non-limiting embodiment;

FIG. 12 illustrates a thumbnail together with additional descriptive information rendered that appears when the thumbnail is clicked or moused over by the store owner, in accordance with a non-limiting embodiment;

FIG. 13 illustrates a product upload form to be filled by the store owner when a new payable content item is to be offered for sale, in accordance with a non-limiting embodiment;

FIG. 14 is a block diagram illustrating an architecture similar to the one of FIGS. 1A and 1B, except that a bidding server is provided to collect bids for payable content items from multiple users, in accordance with a non-limiting embodiment;

FIG. 15 illustrates a variant of the product upload form of FIG. 13, in which information relevant to the auction process is requested from the store owner, in accordance with a non-limiting embodiment;

FIG. 16 illustrates appearance of the e-commerce application to prospective bidders, in which information relevant to the auction process is provided, in accordance with a non-limiting embodiment.

### DETAILED DESCRIPTION

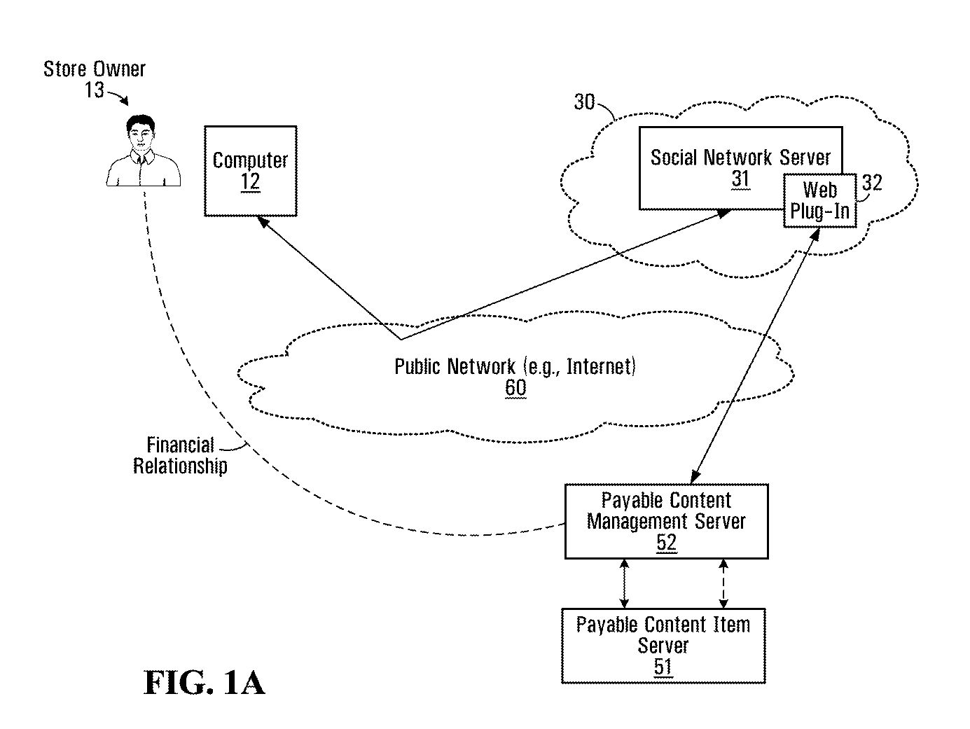

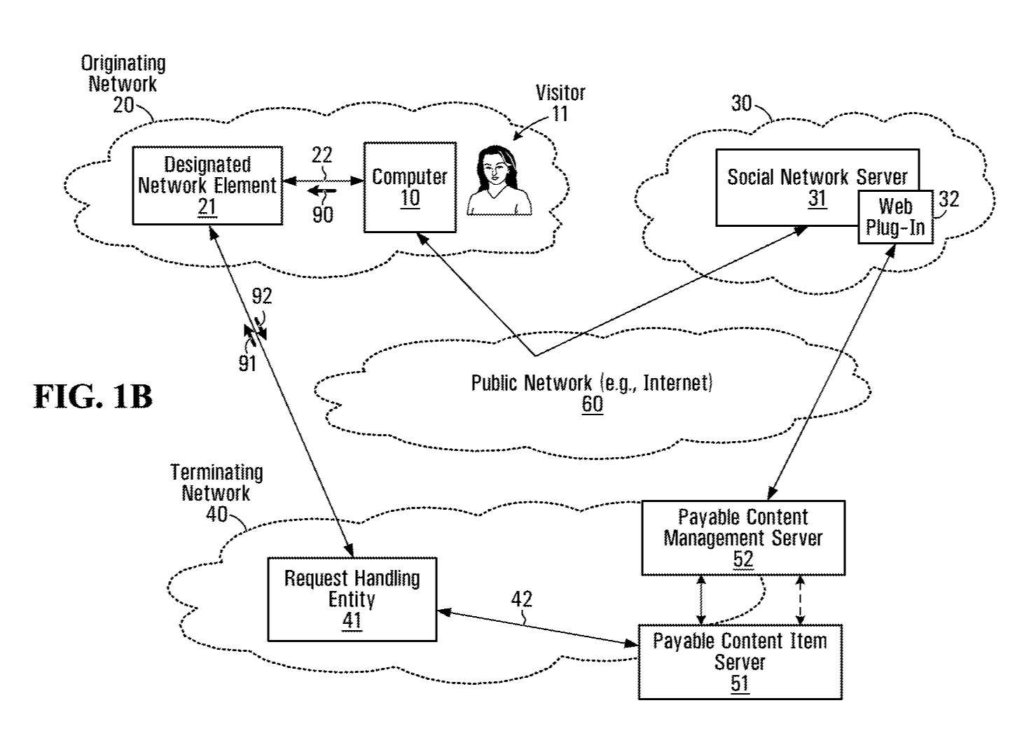

A simplified representation of a multiparty billing architecture according to a specific non-limiting embodiment of the present invention is shown schematically in FIGS. 1A and 1B. The multiparty billing architecture allows members of a social network service 30 to sell content items to friends or other members (e.g., for small amounts on the order of 5 to 50 cents, but not limited thereto).

### Setting Up a Virtual Store

With reference to FIG. 1A, a member of social network service 30 who wishes to sell content to other members of social network service 30 is identified at 13 as a “store owner”. Store owner 13 employs an computing appliance (such as a computer 12, a mobile phone, etc.) to gain access to a social network server 31 over a public network 60 such as the internet. Store owner 13 is assumed to have an account with social network service 30. Access to the store owner's account is gained by supplying the store owner's member credentials to social network server 31. Using social network server 31, store owner 13 can create a profile listing personal interests, contact information, other personal information, free content items and, as will be shown, thumbnails with links to “payable content items” together with prices for the payable content items. Store owner 13 can add friends and send them messages, and update his/her profile to notify friends about himself/herself.

Also provided in the architecture of FIG. 1A are a payable content management server 52 and a payable content item server 51. Payable content item server 51 stores the payable content items (e.g., files) that store owner 13 wishes to sell, while descriptive information relating to the payable content items is stored by payable content management server 52. This descriptive information can include a description, a preview (e.g., a thumbnail file), a price and a location element for each payable content item. Directories reserved for store owner 13 in payable content management server 52 and payable content item server 51 may be employed. For example, when store owner 13 creates a new payable content item (e.g., in the form of a file containing text, graphics, video, audio, etc.), payable content management server 52 stores the descriptive information in a local directory and forwards the payable content item (e.g., the file) to a remote directory, namely one that is maintained by payable content item server 51. Payable content management server 52 and/or payable content item server 51 could be embodied as computing devices that include a processor executing instructions stored on a computer-readable storage medium that implement any existing web solution, for example Java, PHP or Asp.net.

Payable content item server 51 provides payable content management server 52 (and possibly other payable content management servers that it supports) with a set of standard application programming interfaces (APIs) to manage payable content items that belong to each store owner (such as store owner 13). Payable content item server 51 can provide two distinct channels allowing access to the payable content items it stores. For example, a first channel could be for “management” requests, such as requests from payable content management server 52 acting on behalf of store owner 13 to add, remove or replace payable content items being offered for sale. Such management requests would be non-chargeable. A second channel could be for “payable” requests, such as requests from a visiting member of social network service 30 who has requested to purchase a payable content item upon clicking a corresponding thumbnail in the store owner's profile. Such payable requests would be charged back to the visiting member using a multiparty billing system. In order to achieve this dual-channel functionality, a number of embodiments are possible. In a non-limiting embodiment, this can be done using different DNS or IP addresses.

Payable content item server 51 and payable content management server 52 can be hosted by a common network. Social network server 31 can be hosted by the same network that hosts payable content item server 51 and/or payable content management server 52, but this need not be the case. Alternatively, payable content item server 51 and payable content management server 52 may be hosted by different networks and connected by a virtual private network or other communications mechanism. In particular, payable content management server 52 may be connected to payable content item server 51 over the public network 60. Social network server 31 and payable content management server 52 may similarly be connected over the public network 60.

Store owner 13 has a financial relationship with payable content management server 52. For example, payable content management server 52 can be operated by an entity that undertakes to remunerate store owner 13 for sale of payable content items stored by payable content item server 51 on behalf of store owner 13. Charge-back to visiting members of social network service 30 can occur using a multiparty billing service, as will be described in a later part of this specification.

The following describes a possible way in which to cause the storage of payable content items on payable content item server 51 and the storage of descriptive information related to the payable content items on payable content management server 52.

To this end, and in accordance with a specific non-limiting embodiment of the present invention, social network server 31 is adapted to support a web plug-in 32, which enables an e-commerce application for store owner 13. The e-commerce application is hereinafter occasionally referred to as a “MyStore” application. The MyStore application can comprise a set of computer-readable instructions executable by social network server 31. The MyStore application can be represented by an actionable tab or icon presented on the profile page of store owner 13. The computer-readable instructions can be executed (and therefore the MyStore application can be instantiated) when the actionable tab or icon is actioned. The MyStore application includes a shopping component that presents visiting members of the social network service 30 with a preview of the payable content items for sale by store owner 13. In addition, the MyStore application includes an administrative component that allows store owner 13 to manage the payable content items he/she wishes to sell.

Payable content management server 52 backs up web plug-in 32 to provide much of its functionality. Web plug-in 32 and payable content management server 52 could be provided as components of an overall solution in conjunction with payable content item server 51. Alternatively, web plug-in 32 and payable content management server 52 could be offered independently of payable content item server 51.

It should be appreciated that the e-commerce application enabled by web plug-in 32 (i.e., the MyStore application) does not need to be offered explicitly by social network service 30. Rather, in an open system, developers can create a suitable e-commerce application using the available features of Adobe Flash, for example, and integrate the e-commerce application into the profile of a given member of social network service 30.

In a specific non-limiting example, web plug-in 32 can work as part of a profile of store owner 13. Accordingly, web plug-in 32 can be represented by a boxed area or a separate profile tab. It can be tightly integrated with a specific social network service platform. Specifically, a social network service platform may provide application interfaces (APIs) to allow integration with external applications. Web plug-in 32 will use these APIs to interact with the social network server 31 at different levels. Minimally, when creating or updating the MyStore application, store owner 13 should be identified so that uploaded payable content items can be associated with the store owner 13 and only those payable content items that belong to store owner 13 will be shown by the MyStore application. Other integrations also help to promote the MyStore application. For example, when a new payable content item is uploaded to the MyStore application, a message could be sent to all friends of store owner 13. Web plug-in 32 could be implemented as an HTML application with AJAX support, in a social-network-service-specific language or an Adobe Flash application to develop a rich and interactive interface.

Recalling that web plug-in 32 cooperates with payable content management server 52, the communication between these two entities can be varied. For example, Restful web service may be suitable because of its simplicity, although SOAP and WSDL could also be used.

Payable content management server 52 is an external server, which could be hosted anywhere and work with web plug-in 32 and payable content item server 51 via network communication. Payable content management server 52 runs an application that performs much of the functionality presented by web plug-in 32. Since information pertaining to payable content items (except for the payable content items themselves) is kept in payable content management server 52 (such as in a separate dedicated database), payable content management server 52 can provide web plug-in 32 with the functionality to list all payable content items, add a new payable content item and modify/remove an existing payable content item.

Logically, web plug-in 32 and payable content management server 52 are treated as two separate components; however, payable content management server 52 with several web plug-ins 32 for different social networks can be provided as a solution by a single application provider.

Specific non-limiting embodiments of the invention allow store owner 13 to upload a content item (e.g., recipe, music recording, picture, etc.) to a directory reserved for store owner 13 on payable content item server 51 and to use the ability of web plug-in 32 (such as Flash Player) to add animation, video and interactivity to any web pages, in order to display a thumbnail stored on payable content management server 52 with a web link pointing to the payable content item in a new profile tab in the store owner's social network profile. Payable content item server 51 charges purchasers of the payable content item through multiparty billing of telecommunications services, as will be shown later on.

Because the application running on payable content management server 52 only displays thumbnails with associated links on the created profile tab of social network service 30, the uploading of payable content items, the browsing of payable content items and the purchase of payable content items can all be carried out without any positive actions—or even awareness—by social network server 31. Simply put, existing social network platforms would not need to be modified or adapted to support this model.

Now will be described a manner in which store owner 13 can set up the MyStore application in his/her social network profile; link the MyStore application to a directory on payable content management server 52; administer the MyStore application such as by uploading payable content items to payable content item server 51 or deleting payable content therefrom; and review all payable content in the MyStore application.

The example social network service selected to illustrate the processes to do the above-mentioned actions will be Facebook. However, the invention is not limited to Facebook and can be extended to other social network services such as, without limitation, MySpace, LinkedIn, Classmates.com, Fotolog, Qzone, Viadeo, WeeWorld, Windows Live Spaces, Cyworld, etc.

### Part I—Installation

a) Login to Facebook
Store owner 13 logs in to his/her FaceBook account via a web browser (such as Internet Explorer, Firefox, Chrome, etc.) It is assumed that the computer 12 being used by store owner 13 has the requisite capabilities (e.g., Adobe Flash) to run the MyStore application. If not, FaceBook can guide store owner 13 through a process of installing the necessary software.

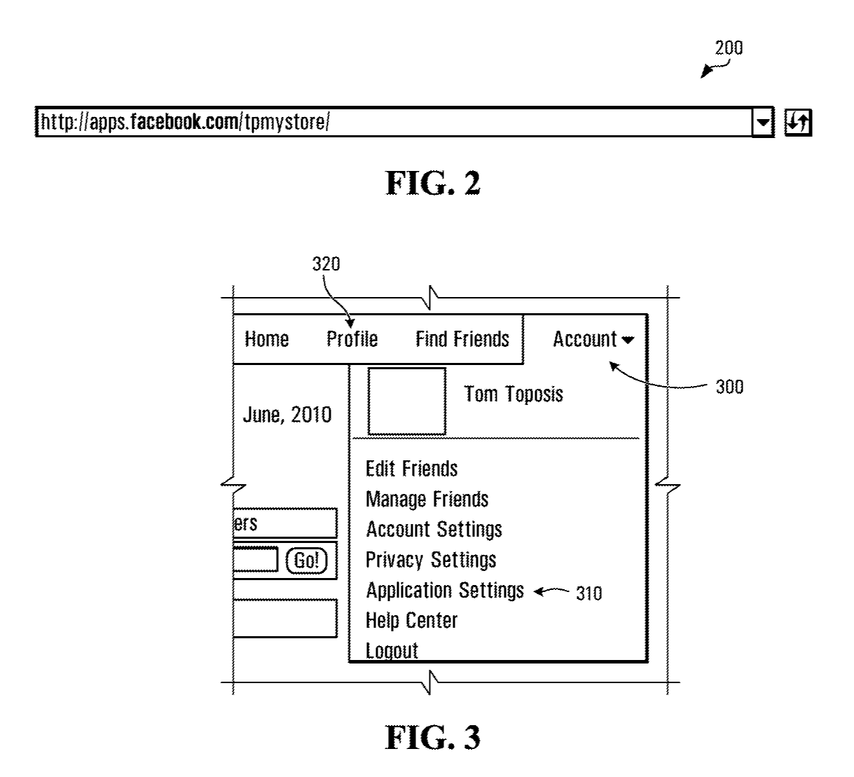

b) Application Authorization in Facebook
Store owner 13 goes to a URL where a specific application is identified, e.g., the MyStore application. This URL could be hosted by FaceBook, for example, http://apps.facebook.com/tpmystore/. Other possibilities exist and are within the scope of the present invention. With reference to FIG. 2, the URL can be entered in an address bar 200 in order to authorize the MyStore application to access the store owner's personal information.

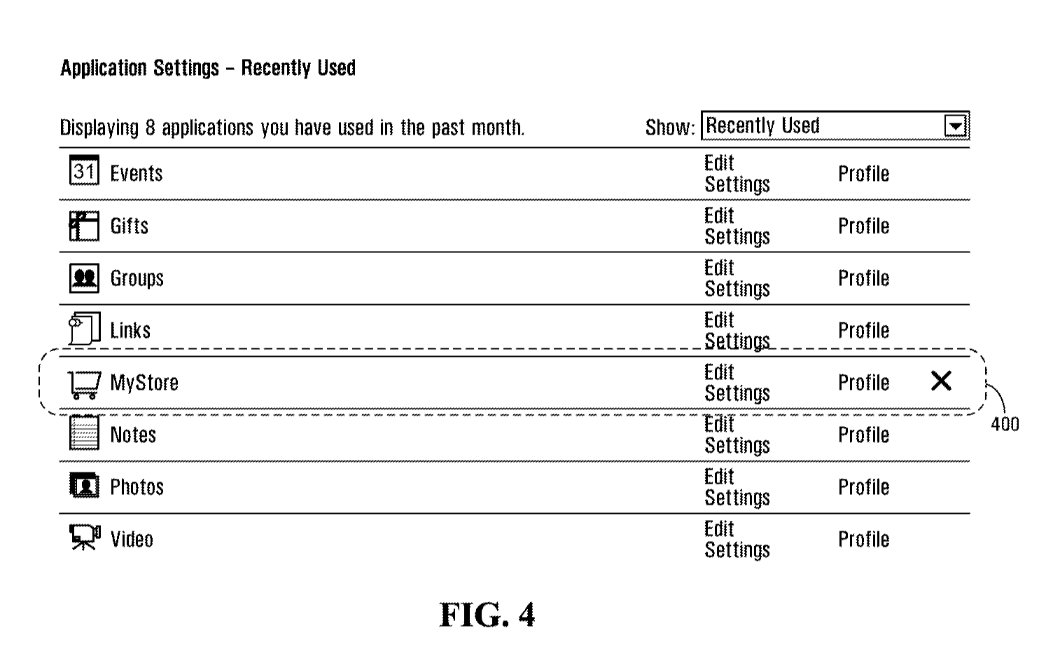

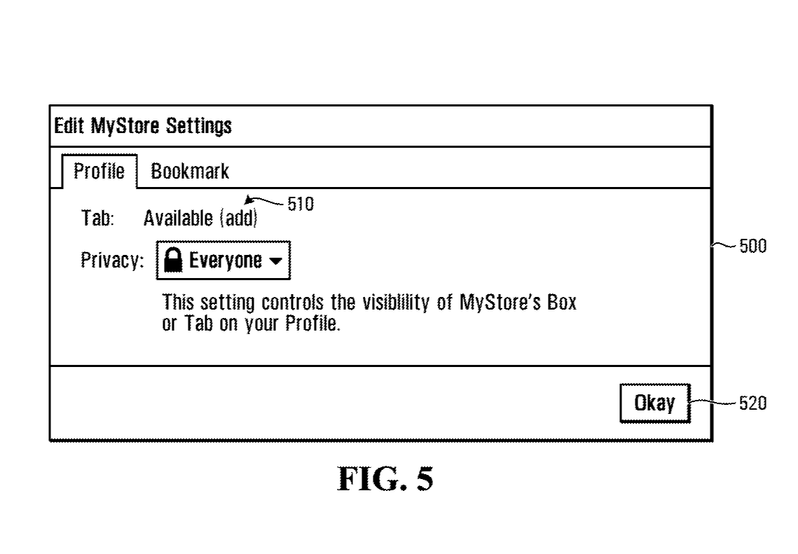

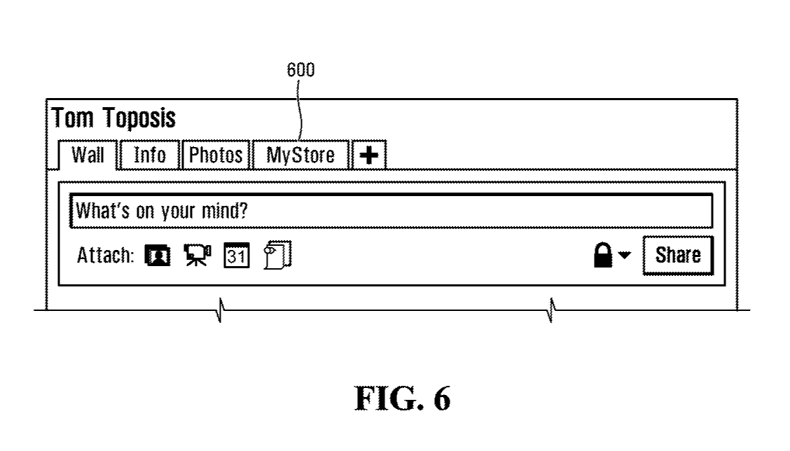

c) Add the MyStore Application to Store Owner's Profile
With reference to FIG. 3, store owner 13 clicks “Account” 300 on the FaceBook menu, and selects “Application Settings” 310 from the drop-down menu list. With reference to FIG. 4, this brings up a page listing applications visited, including a row 400 corresponding to the MyStore application. Store owner 13 locates “MyStore” and clicks “Edit Settings” to configure the MyStore application. With reference to FIG. 5, this produces a configuration page 500, which can be in the form of a pop-up. On the configuration page 500, store owner 13 clicks the “(add)” link 510 beside “Tab: Available” and then clicks the “Okay” button 520 to close the pop-up.
Reference is now made to FIG. 6, which shows the effect of having selected the profile tab 320 in the FaceBook menu of FIG. 3 once the above steps have been followed. It is seen that the MyStore application is present as an extra tab 600 along with other tabs forming the store owner's profile.

d) To Remove the MyStore Application from Store Owner's Profile
It should be appreciated that if store owner 13 wishes to remove the MyStore application from his/her profile, store owner 13 can select the “Application Settings” 310 from the “Account” 300 menu (see FIGS. 3 and 4). Then, store owner 13 finds “MyStore” and click the “X” on the far right; the MyStore application will be removed right away from the store owner's profile.

### Part II—Binding

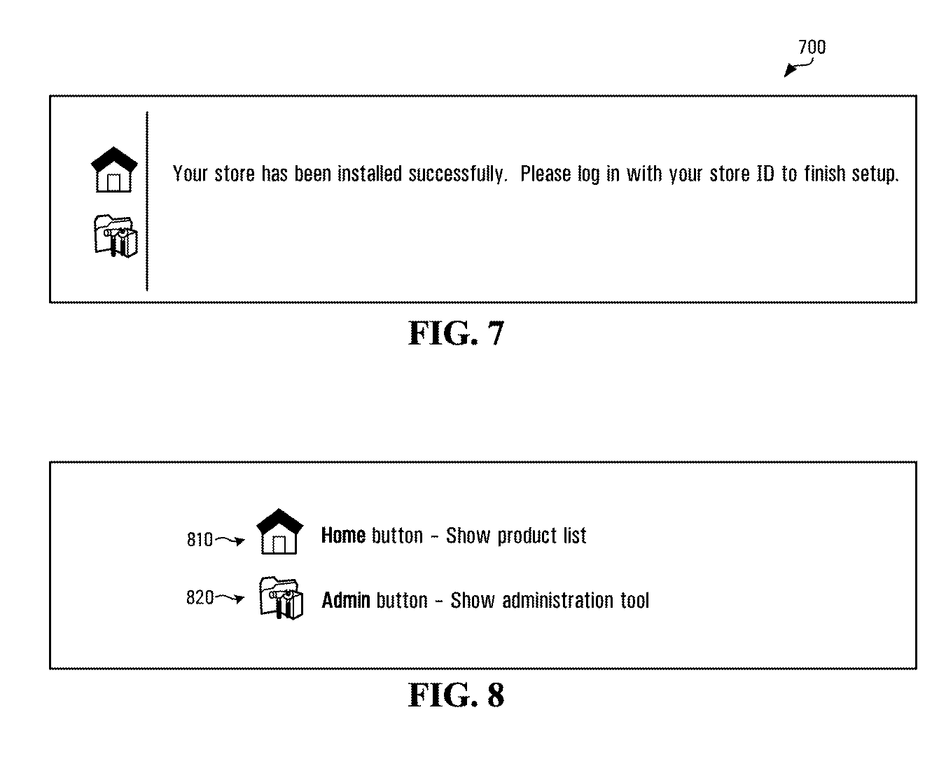

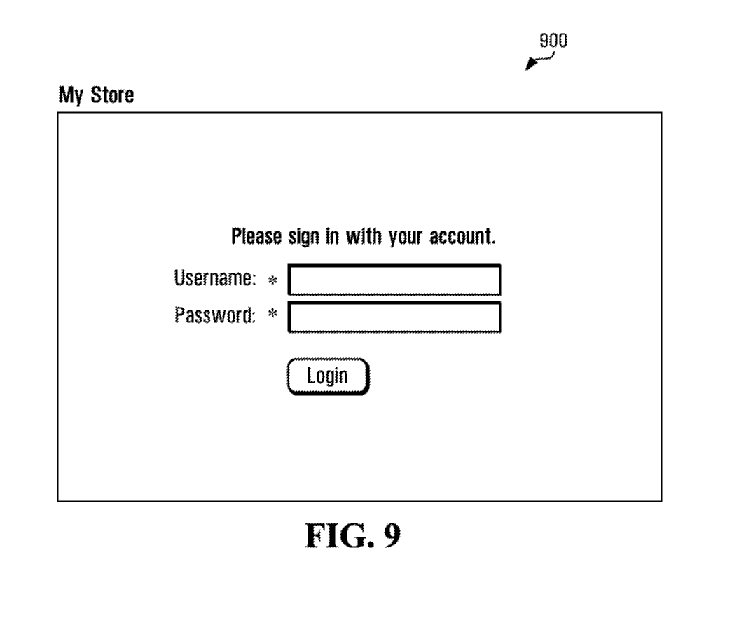

Once the MyStore application is represented among the store owner's profile tabs, then either automatically or in response to clicking the “MyStore” tab 600 in FIG. 6, the MyStore application is invoked for the first time. With reference to FIG. 7, this can cause a page 700 to appear. Page 700 indicates that store owner 13 has successfully finished PART I (i.e., installation) and now is invited to move to Part II in order to set up the store owner's MyStore application and make it work.
The MyStore application, which is implemented by virtue of web plug-in 32, can be written in the Adobe Flash Player, which is a software program for viewing animations, movies and adding inactivity such as web links using computer programs such as a web browser.
The appearance of the MyStore application can be made as simple or as complex as desired. For example, with reference to FIG. 8, the main navigation bar on the left can have two buttons, namely a “Home” button 810 and an “Admin” button 820. This reflects the two components of the MyStore application. Specifically, the MyStore application includes a shopping component that presents visiting members of the social network service 30 with a preview of the payable content items for sale by store owner 13. Visiting members of social network service 30 who access the MyStore application via the store owner's profile thus use the “Home” button 810 to navigate to the product list (list of payable content items) from a detailed product page.
In addition, the MyStore application includes an administrative component that allows store owner 13 to manage the payable content items he/she wishes to sell. Thus, the “Admin” button 820 is only for use by store owner 13, as described further below.
Before the MyStore application can be rendered functional, store owner 13 is assumed to have been associated with a directory in payable content management server 52 and a directory in payable content item server 51. This can be achieved by contacting the administrator of payable content management server 52 and subscribing to a payable content service. This was referred to earlier as the “financial relationship” between store owner 13 and payable content management server 52 (or an operator thereof). Assuming the existence of such a relationship, payable content management server 52 can take care of creating a directory associated with store owner 13 in payable content item server 51, either through internal communication within the same entity or through external communication (e.g., over the public network 60). The existence of a directory associated with store owner 13 in payable content item server 51 allows store owner 13 to be remunerated when payable content items are delivered to—and paid for by—visiting members who use the store owner's MyStore application.
With the above pre-requisites having been satisfied, store owner 13 binds the MyStore application to his/her directory in payable content management server 52. This “binding” need be done only once, for example as store owner 13 signs in to the MyStore application for the first time. To do so, store owner 13 clicks the “Admin” button 820 on the navigation bar, following which, as shown in FIG. 9, a window 900 may be presented.
Store owner 13 signs in to payable content management server 52 with his/her credentials (e.g., username and password) that establish the existence of the aforementioned financial relationship between store owner 13 and payable content management server 52 (or an operator thereof). For example, the credentials entered by store owner 13 via window 900 can pertain to an account that store owner 13 has previously established with payable content management server 52. After store owner 13 has been authenticated by payable content management server 52, the binding is complete.
As mentioned above, binding only need occur when store owner 13 signs in for the first time. Upon binding, visiting members (members of the social network service 30 who visit the store owner's profile page) can now see the store owner's payable content items under the MyStore tab 600. In an embodiment, the MyStore application is configured to allow visiting members to see the thumbnails corresponding to the store owner's payable content items at all times, regardless of whether store owner 13 is signed in or not.

### Part III—Administration

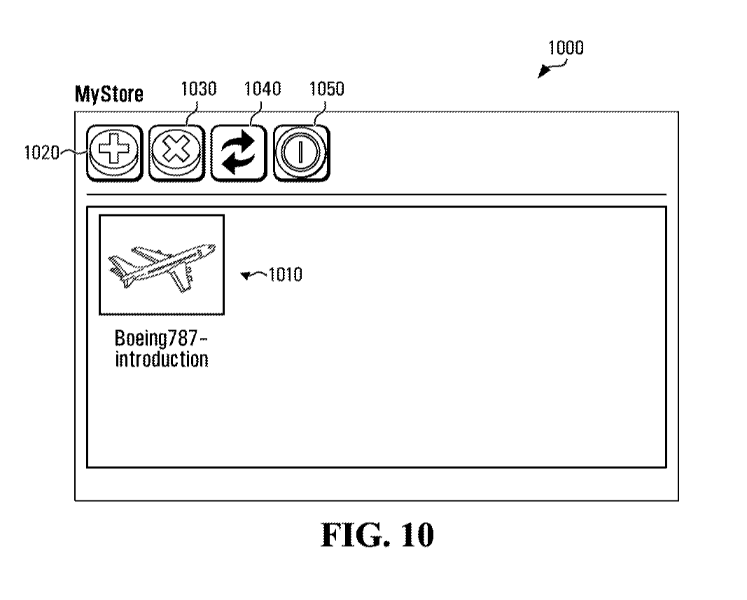

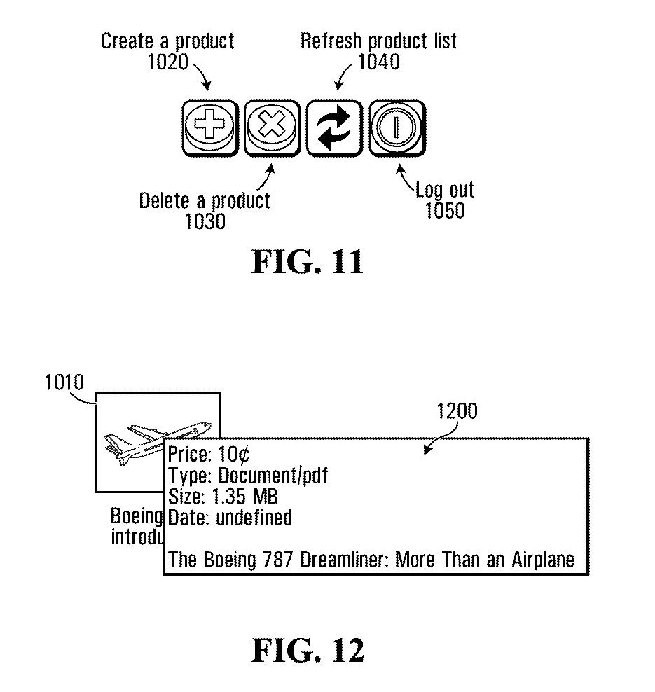

By signing in to the MyStore application, store owner 13 can add, remove and modify thumbnails representative of payable content items, all of which are presented through the capabilities of web plug-in 32. FIG. 10 illustrates an example admin window 1000 that may appear once store owner 13 has successfully signed in after clicking the “Admin” button 820 (see PART II above). After store owner 13 has signed in, the set of preview items (e.g., thumbnails) corresponding to the payable content items will be shown by default. In this specific case, admin window 1000 includes a single thumbnail 1010 showing an airplane. However, the number of thumbnails is not particularly limited, nor is their content, nor is the content that they represent.
Store owner 13 can use the administrative component of the MyStore application to manage the payable content items being offered for sale. Specifically, this can be done using buttons 1020, 1030, 1040, 1050, which are shown in more detail in FIG. 11. Specifically, button 1020 allows the creation of a payable content item, button 1030 allows the deletion of a payable content item, button 1040 allows a re-display of the list of payable content items and button 1050 allows logout functionality. These are described in further detail.

a) Show all Products
Refresh button 1040 can be clicked to refresh the list of payable content items for display in the admin window 1000. Each time refresh button 1040 is actioned, web plug-in 32 contacts payable content management server 52 to obtain the necessary information to be displayed for store owner 13. The information regarding each payable content item is obtained by web plug-in 32 from payable content management server 52 and, more specifically, from the store owner's directory on payable content management server 52 to which the MyStore application has been bound. By mousing over (or clicking on) the thumbnail 1000, a pop-up can be made to appear, thus allowing store owner 13 to see additional descriptive information relating to the individual payable content item, such as a name, price, etc. As shown in FIG. 12, this information could be supplied in the form of a text box 1200, but this is not to be considered limiting. It is noted that in the illustrated embodiment, the descriptive information shown in the text box 1200 corresponding to an individual payable content item does not include a location element for the payable content item. In an alternative embodiment, the location element could be shown.

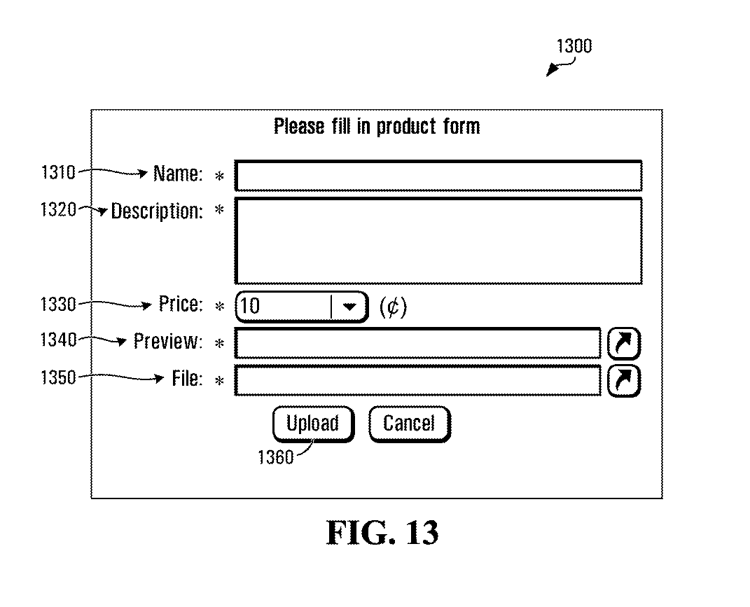

b) Create a Product
With reference to FIGS. 10 and 13, clicking Add button 1020 will cause a product upload form 1300 to appear. Filling out the product upload form 1300 allows the creation of a new payable content item. The product upload form 1300 has the following fields:
Name 1310: the name to be given to the payable content item.
Description 1320: the description to be given to the payable content item.
Price 1330: there could be a suggested price, or a suggested price range, or an actual limit on price, or there could be no suggestion at all. The denomination could be dollars, cents, different currencies, etc.
Preview 1340: the product preview image. For example, .JPG and .gif formats could be supported. A browse functionality could be invoked in order to find the preview image on the store owner's computer 12.
File 1350: the product content file. A browse functionality could be invoked in order to find the file on the store owner's computer 12. Different file formats may be suitable, depending on the nature of the payable content item.
After the product upload form 1300 has been filled in, store owner 13 can click an “Upload” button 1360 to start the uploading (or a “Cancel” button can be clicked at any time to return to list of payable content items and their thumbnails).
The uploaded information regarding the payable content item is sent to payable content management server 52. Payable content management server 52 stores all the information (except the actual file specified in field 1350) in the directory associated with store owner 13. This directory can be referred to as a non-limiting example of a “local location”. The actual file is sent by payable content management server 52 to payable content item server 51 and is stored in the directory there that is associated with store owner 13. This directory can be referred to as a non-limiting example of a “remote location”.

c) Delete a product
Store owner 13 clicks on a thumbnail and then clicks the delete button 1030. This may be followed by confirming the deletion via a confirmation pop-up that is subsequently made to appear. The information regarding the payable content item to be deleted is sent to payable content management server 52, which then removes the thumbnail from the directory associated with store owner 13 and also instructs payable content item server 51 to delete the payable content item from the directory associated with store owner 13.

d) Logout
After store owner 13 has finished using administrative component of the MyStore application, the “logout” button 1140 can be clicked to sign out of the administrative component.

Those skilled in the art should appreciate that the above description is not to be considered limiting. Specifically, any reference to buttons, graphical layouts and data fields is merely for illustrative purposes, and many variants can be conceived without departing from the scope of the invention.

Once store owner 13 has completed the upload of a payable content as described above, one can envisage the use of a feature analogous to “AutoShare” from Google, which allows one to automatically share an “Activity Feed” to FacebBok, Twitter and Google Reader. By opting into such an automatic sharing feature, when store owner 13 uploads a new payable content item to the MyStore application, the automatic sharing feature sends an update to friends on FaceBook, a tweet on Twitter, and/or a notification in Google Reader about the availability of the new payable content item. Now all of the store owner's friends are altered, and they can be incited to access the store owner's FaceBook profile in order to see the new payable content item that is being offered for sale. Other possibilities exist and are within the scope of the present invention.

Once a payable content item has been uploaded, a location element for the payable content item may be generated and stored. The location element for the payable content item can be generated by the web plug-in 32, by payable content management server 52, by payable content item server 51 or by another suitable entity.

The location element for the payable content item can be an internet address. Now, it should be appreciated that the location element will be returned to a requesting user (e.g., a visiting member of the social network service 30). Therefore, it is possible to configure the location element to include a predetermined URL of a designated network entity in an originating network where, it is assumed, a future visiting member will have a customer account. Thus, when this URL is submitted by the visiting member's computer to a DNS server, the DNS server will recognize the predetermined URL and send the location element to the designated network entity in the originating network. The designated network entity then will route the location element to payable content item server 51, where the payable content item will be retrieved. Now, if the originating network has an inter-organizational billing arrangement with payable content item server 51 or payable content management server 52 (or their respective operators), then a billing process can be triggered between these two entities whereby payable content item server 51 or payable content management server 52 can charge the originating network for releasing the payable content item. Yet because of the customer account that the visiting member has with the originating network, the originating network can charge back the visiting member. Thus, the location element can be designed to comprise an address of (or a URL with a domain name that is routable by a domain name server to) a designated network entity operated by an organization with which an operator of payable content management server 52 and/or payable content item server 51 has an inter-organizational billing arrangement.

A non-limiting example of a location element could be “pay.MyStore.com/boeing_{—}787”. The string “pay.” could be recognized by a DNS server as pointing to a designated network entity in the originating network where, it is assumed, a future visiting member will have a customer account. The designated network entity then will recognize the string “MyStore.com” as being associated with payable content item server 51 and will route the location element accordingly. Payable content item server 51 recognizes “boeing_{—}787” as being in its database in association with store owner 13, releases the corresponding payable content item (e.g., a high-resolution graphics file), charges the originating network via an inter-organizational billing arrangement and remunerates store owner 13. The originating network can charge back the visiting member. Of course, other formats of the location element are possible and it is to be understood that they are within the scope of the present invention.

If the location element for the payable content item is generated by payable content management server 52, then it can be stored in the directory associated with store owner 13 and in association with the payable content item that it corresponds to. A copy may also be sent to payable content item server 51 so that it knows which payable content item to release in response to a request from a visiting member that contains this particular location element. If the location element for the payable content item is generated by the web plug-in 32 or payable content item server 51, then it may be forwarded to payable content management server 52 for storage.

### Use of the MyStore Application by Visiting Members

The above-described process allows store owner 13 to upload payable content items to the store owner's directory on payable content item server 51, while preview items (e.g., thumbnail files) associated with the payable content items are maintained in the store owner's directory on payable content management server 52. Also, a location element for each payable content item is created, and is maintained by content management server 52. When a visiting member of the social network service 30 accesses the store owner's profile and instantiates the MyStore application, the MyStore application establishes a connection with payable content management item server 52 and allows the visiting member to view the preview items (e.g., using a browser). When the visiting member actions the preview item corresponding to a desired payable content item, a series of multiparty telecommunication billing events is initiated. For an exemplary embodiment of such events, one can refer to PCT Patent Application serial no. PCT/CA2010/000751, filed on May 14, 2010 and hereby incorporated by reference herein. Nevertheless, some details of operation will be provided here to aid in understanding.

Specifically, with reference to FIG. 1B, payable content item server 51 is placed behind a request handling entity 41 in a terminating network 40. Request handling entity 41 acts as a gateway to payable content item server 51 and is responsible for making sure that an access fee is billed before the desired payable content item can be accessed. Consider that a visiting member of the social network service 30 (hereinafter visitor 11) uses an computing appliance (such as a computer 10, mobile phone, etc.) to access social network server 31.

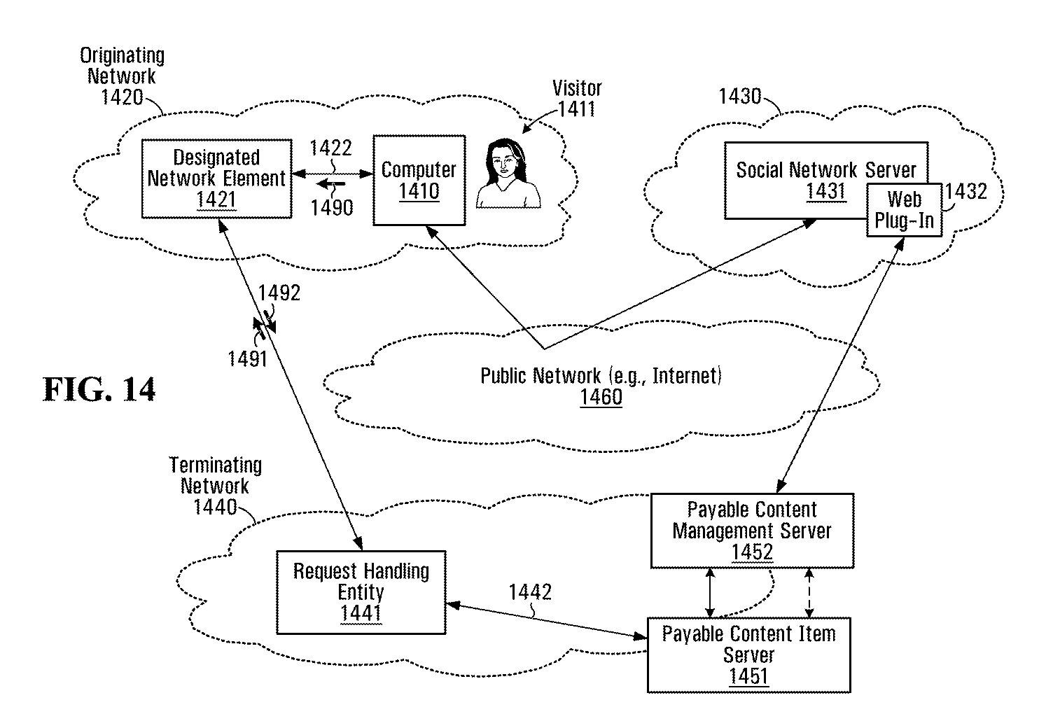

It is assumed that the visitor 11 has a customer account with the aforementioned originating network which, it will be recalled, is operated by an entity that has an inter-organizational billing relationship with payable content item server 51 and/or payable content management server 52. In FIG. 14, the originating network is denoted by the reference character 20.

The originating network 20 could be the network that the visitor 11 uses to gain access to the public network 60, but this is not a requirement. In an embodiment, the originating network 20 comprises a designated network entity 21 as well as a domain name server (DNS, not shown). In an embodiment, the DNS handles queries issued by the device 10 whenever a domain name is to be accessed. In an embodiment, the DNS keeps a list of “special” domain names which, if present in a requested URL, are considered to pertain to requests for payable content items and are therefore to be handled in a different way from other domain names. Thus, if the device 10 were to consult the DNS for the IP address corresponding to a given URL, the DNS would check the domain name of this URL against the list. If it is on the list, the DNS would return the IP address of the designated network entity 21 in the originating network 20. Accordingly, the device 10 would send a message, comprising at least part of the originally requested URL, to the designated network entity 21. In contrast, if the domain name of the requested URL is not on the list, then the query from the device 10 would be handled as a standard DNS query, which would be resolved into an IP address other than that of the designated network entity 21.

Now consider that the visitor 11 selects the thumbnail 1010 in FIG. 10 that represents a desired payable content item. This causes the MyStore application to return a location element that had been stored by payable content management server 52 in association therewith. This location element can be a URL with a special domain name, e.g., “pay.MyStore.com/boeing_{—}787”. The device 10 issues a DNS query to the DNS (not shown) based on the URL “pay.MyStore.com/boeing_{—}787”. The DNS recognizes that the domain name of the received URL is a “special” domain name, e.g., due to the fact that the domain name of the received URL is prefixed by the string “pay” (this is just an example, as other techniques used to encode and decode “special” domain names are possible). The DNS returns the IP address of the designated network entity 21 in the originating network 20. The device 10 thus directs a message 90 (e.g., an HTTP call) to the designated network entity 21. Message 90 includes at least part of the originally requested URL (in this case “pay.MyStore.com/boeing_{—}787”).

The designated network entity 21 recognizes that message 90 received from the device 10 is a request for a payable content item for a customer of originating network 20. In this case, the customer in question is the visitor 11. The designated network entity 21 decides whether to accept to be charged by a third party on behalf of visitor 11. One of the steps in this decision making process may involve the designated network entity 21 verifying (e.g., by consulting a database) whether the visitor 11 has subscribed to an online payment service offered by the originating network 20.

Assuming that the visitor 11 was indeed found to subscribe to an online payment service offered by the originating network 20, the identity of the visitor 11, the contents of message 90 received from device 10, as well as the time and any other relevant information can be collected by the designated network entity 21 as usage data. Based on the usage data for the present request and other requests made by other ones of its customers, the designated network entity 21 will at some later time be able to reconcile the usage data with the information contained in service records received from the terminating network 40 in order to charge the appropriate customer, including the visitor 11.

The designated network entity 21 then formulates a payable item request 91 for transmission to an appropriate request handling entity. In order to identify the IP address of the appropriate request handling entity to which it is to forward the payable item request, the designated network entity 21 consults a database (not shown) or other resource based on the domain name of the originally requested URL. The database or other resource maintains information regarding which request handling entities in which terminating networks act as the gateways to the domain names where various payable content items are stored. In this example, the appropriate request handling entity is found to be the request handling entity 41 in the terminating network 40. This aforementioned database can be implemented by the Domain Name System without modifications specific to the originating network 20, where an (unmodified) domain name server directs the payable item request processed by the designated network entity 21 to the request handling entity 41. Optionally, the designated network entity 21 may modify the domain name in the originally requested URL, if the actual domain of the request handling entity 41 is not one that is on the list stored in the DNS.

The designated network entity 21 sends the payable item request 91 to the request handling entity 41, e.g., over the public network 60. The payable item request 91 includes at least part of the originally requested URL (in this case “pay.MyStore.com/boeing_{—}787”). In a non-limiting embodiment, the payable item request can be an HTTP call. If, in addition, the visitor 11 was found to subscribe to an online payment service, the designated network entity 21 inserts authentication data into the payable item request. By way of non-limiting example, the authentication data can include an identifier of the originating network 20. For enhanced security, the authentication data can also include a version of this same identifier but encrypted with a private key of the originating network 20.

Since the request handling entity 41 may be the gateway to multiple payable content item servers (including payable content item server 51), upon receipt of the payable item request 91 from the designated network entity 21, the request handling entity 41 identifies the correct database from which to retrieve the desired payable content item. The correct database can be identified based on part of the originally requested URL contained in the payable item request 91. In this example, the desired payable content item is held by payable content item server 51.

If authentication data was supplied as part of the payable item request 91, the request handling entity 41 verifies the information (e.g., by a decryption technique, which could be based on a public key of the originating network 20). If the authentication data is successfully verified, this will reveal the identity of the entity to be charged for the desired payable content item (in this case, it is the originating network 20).

Also, the request handling entity 41 determines the price of the requested payable content item. The price can be obtained by consulting a pricing database or by querying payable content item server 51 directly. The request handling entity 41 then sends a message 92 back to the designated network entity 21. Message 92 causes a confirmation page to be displayed by the device 10. In addition, message 92 may also include a request for credit clearance destined for the designated network entity 21, to ensure that the originating network 20 will agree to be billed for the price of the desired payable content item (in addition to, possibly, a commission).

The price of the desired payable content item may be modified by adding commissions as the confirmation passes through the terminating and the originating networks. Alternatively, the price given in the aforementioned pricing database may already include commissions, in which case the price confirmation will not be altered, but the specified price can be divided between the originating network 20, the terminating network 40, and payable content item server 51 (or payable content management server 52), according to predefined rules.

In an embodiment, when the price confirmation request is received by the originating network 20, the originating network 20 can determine whether the visitor 11 has sufficient credit to pay for the desired payable content item. Alternatively, the originating network 20 can determine whether the visitor 11 has credit within a credit limit. It is noted that the credit limit may be adjusted as needed by the originating network 20, depending on various parameters such as a service class. It is also noted that the originating network 20 may authorize the visitor 11 to further decrease its own credit limit in general or for specific services, to a value below the credit limit set by the originating network 20.

Upon receiving confirmation from the visitor 11, the request handling entity 41 contacts payable content item server 51, supplying it with enough of the originally requested URL that the desired payable content item can be identified. In response, payable content item server 51 returns the desired xxx payable content item, in this case a high-resolution image of the Boeing 787 aircraft, to the request handling entity 41. The request handling entity 41 forwards the image to the designated network entity 21, which then forwards the image to the device 10 for usage and enjoyment by the visitor 11.

The billing flow is now described. Specifically, the terminating network 40 sends a service record indicative of a first charge to the originating network 20 via an inter-organizational billing arrangement. This could be carried out between the operators of the respective networks 20, 40. As such, the originating network 20 will be informed that it owes the terminating network 40 a certain amount of money or, in the case of a prepaid account, that its prepaid balance has been debited by a certain amount. The amount of the first charge can be the price of the payable content item plus a commission for the terminating network 40 plus a commission for the originating network 20 (in addition to other commissions, if the charging and payment collection happens through additional intermediaries). Alternatively, the price of the desired payable content item can already include a portion that constitutes a commission for the terminating network 40 and/or the originating network 20.

The originating network 20 can then reconcile the service record received from the terminating network 40 with previously collected usage data (mentioned above) and can transfer at least a portion of first charge to the visitor 11. This can be achieved by issuing a second charge to the visitor 11, who has a customer account with the originating network 20. As such, the visitor 11 will be informed that he/she owes the originating network 20 a certain amount of money or, in the case of a prepaid account, that its prepaid balance has been debited by a certain amount. The amount of the second charge can be the amount of the first charge plus a commission for the originating network 20.

Variants are of course possible. For example, the originating network 20 may comprise a domain name server (DNS) together with a routing entity that applies special routing to IP addresses in a designated pool. Specifically, when a message is to be routed to an IP address in the pool, it is known that such a message pertains to a request for a payable content item, and therefore such a message is to be handled differently from messages destined for IP addresses that are not in the pool. Thus, when routing a message from the device 10 to a particular IP address (which would be obtained from the DNS), the routing entity checks to see if the IP address is in the designated pool. If it is in the pool, the routing entity reroutes the message to the designated network entity 21 in the originating network 20. In contrast, if the IP address is not in the pool, then the routing entity need not modify the destination of the message issued by the device 10.

### Auctions

One can also envisage that there can be many different types of online transactions that can be performed by store owner 13 other than selling content online for a fixed price. One such type of transaction is an online auction to allow a group of friends of the store owner to bid for a certain payable content item over the public network 60 at any time over a specified period, in order to determine the winning bid, and to allow the winning bidder to pay for the certain payable content item using multiparty billing of telecommunications services. This is now described with reference to a specific non-limiting embodiment of present invention.

Accordingly, FIG. 14 shows an architecture similar to that of FIGS. 1A and 1B, except that a bidding server 1400 replaces payable content management server 52.

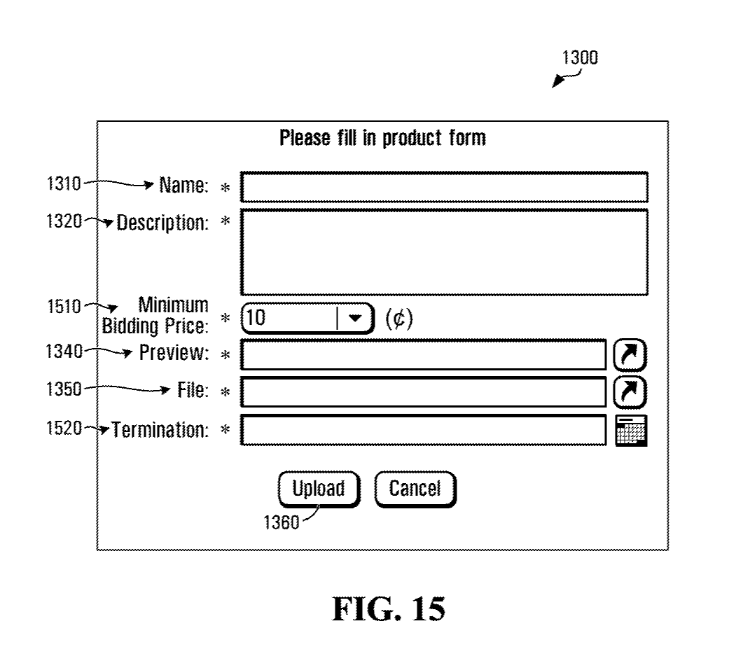

Using an uploading process similar to the one described with reference to FIGS. 1A to 13, store owner 13 can upload payable content items to his/her directory in payable content item server 51 and can upload the corresponding thumbnails to the bidding server 1400. During the uploading process, and with reference to FIG. 15, a variant of the product upload form 1300 can be used. Here, rather than a price field 1330, the upload form 1300 includes a minimum bidding price 1510 field. This field is used by store owner 13 to enter a price below which he/she is not willing to sell a certain payable content item. Another field provided on the upload form 1300 in FIG. 15 is a termination 1520. This is used by store owner 13 to enter a date and/or time that delimits the bidding process, that specifies the time until which bids will be collected/accepted. In another embodiment, there is provided a field that would allow store owner 13 to enter a future start time for the auction. After the product upload form 1300 in FIG. 15 has been filled in, store owner 13 can click an “Upload” button 1360 to start the uploading (or a “Cancel” button can be clicked at any time to return to list of payable content items and their thumbnails).

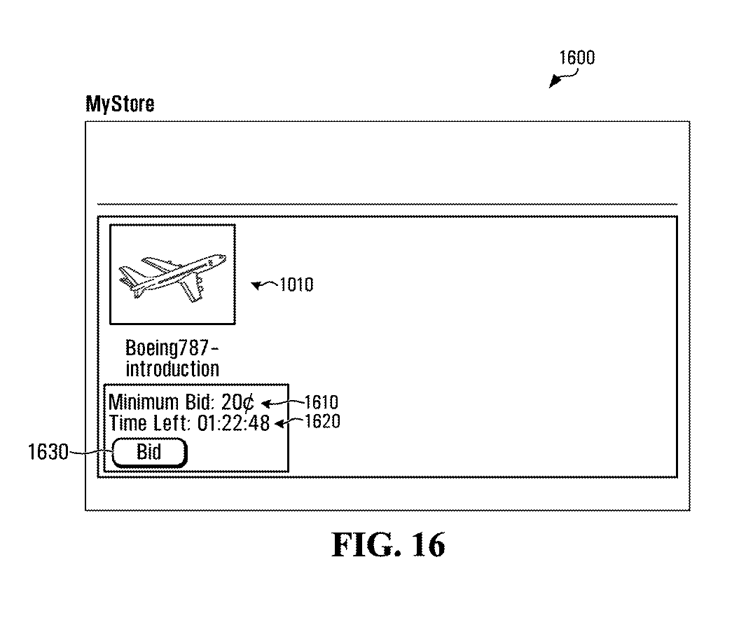

FIG. 16 illustrates appearance of the shopping component of the MyStore application in the case where the certain payable content item is up for auction. In this specific case, a window 1600 includes the thumbnail 1010 showing an airplane. In addition, information relevant to the bidding process is provided. Specifically, a bid button 1630 is optionally provided, to incite prospective bidders to place a bid. This has the effect of placing the prospective bidder in communication with the bidding server 1400, which prompts the prospective bidder to place a bid and provide contact information. This information (which can include an email address) is collected by the bidding server 1400 in case the prospective bidder wins the auction, so that the bidding server knows where to send the “prize”, i.e., the location element of the certain payable content item. The same effect can be achieved by allowing the prospective bidder to simply click (or double click) on the thumbnail 1010. In addition, and in the interest of providing the prospective bidder with additional information, a minimum bid (in this case 20 cents) is shown in a graphical area 1610 and the amount of time left (or potentially only the termination date/time) is shown in a graphical area 1620. Of course, many variations in layout and in the types and amount of information displayed are possible and would be recognized by a person skilled in the art as being within the scope of the present invention.

The bidding server 1400 will continue to collect bids until the termination bidding date/time. At that point, the bidding server 1400 will determine the winning bid and contact (e.g., send an email to) the winning bidder (e.g., the bidder who placed the highest bid) with the location element of the payable content item. The location element can be a URL or other link, but is not limited thereto.

When the winning bidder clicks the winning link information in his/her email, a series of multiparty telecommunication billing events is initiated. For an exemplary embodiment of such events, one can refer to PCT Patent Application serial no. PCT/CA2010/000751, filed on May 14, 2010 and hereby incorporated by reference herein. Some details of operation have also been provided above to aid in understanding. At the conclusion of the multiparty telecommunication billing events, the bidding server 1400 (or an operator thereof) will have collected the amount of the bid (in addition to potentially a commission) and will remunerate store owner 13. This can be in any known way such as a cheque, a credit towards goods/services, a wire transfer, loyalty points, etc. A commission can be charged by the bidding server 1400, either by increasing the amount collected from the originating network or by reducing the amount paid out to store owner 13.

Thus, it will be appreciated that certain embodiments of the present invention allow the social relationships in a social network to be exploited in order to get a group of users to bid for a payable content item over the internet in an online auction process in which the initial price starts low and is bid up by successive bidders. It is conceivable that bids could be placed at any time (24/7). The payable content item can be listed for a number of days at the discretion of the seller (e.g., between 1 and 10), giving prospective bidders time to search, decide, and bid. The convenience of this system can potentially increase the number of bidders (and therefore the final sale price).

It should also be appreciated that certain embodiments of the invention can use the secure key distribution management and generation of billing records for multiparty billing as described in previous PCT Patent Application serial no. PCT/CA2008/001946 filed 7 Nov. 2008 entitled “Systems and Methods for Multiparty Billing of Network Services”, hereby incorporated by reference herein.

It should further be appreciated that the system is applicable for online billing (e.g. of prepaid accounts) as well as for offline billing (postpaid billing). Beneficially, all respective information can be transferred over a shared infrastructure, in particular, over the public internet.

The above-described embodiments of the invention are intended to be examples, and alternatives and modifications to the embodiments may be made by those of skill in the art, without departing from the scope of the invention which is defined by the claims appended hereto.

1. A non-transitory computer-readable storage medium storing computer-readable instructions for execution by a social network server, wherein execution of the instructions causes the social network server to implement a method that comprises:
establishing a connection to a payable content management server that stores a set of preview items corresponding to payable content items and a location element for each payable content item;
rendering the preview items accessible to a computing appliance connected to the social network server;
receiving an indication that a particular one of the preview items has been selected using the computing appliance; and
forwarding to the computing appliance the location element for the payable content item corresponding to the selected preview item.

2-6. (canceled)

7. The storage medium defined in claim 1, wherein the location element for the payable content item corresponding to the selected preview item comprises an address of a designated network entity operated by an organization with which an operator of the payable content management server has an inter-organizational billing arrangement.

8. The storage medium defined in claim 1, wherein the location element for the payable content item corresponding to the selected preview item comprises a URL with a domain name that is routable by a domain name server to a designated network entity operated by an organization with which an operator of the payable content management server has an inter-organizational billing arrangement.

9. The storage medium defined in claim 1, wherein the payable content items are stored on a payable content item server and wherein the location element for the payable content item corresponding to the selected preview item comprises an address of a designated network entity operated by an organization with which an operator of the payable content item server has an inter-organizational billing arrangement.

10. The storage medium defined in claim 1, wherein the payable content items are stored on a payable content item server and wherein the location element for the payable content item corresponding to the selected preview item comprises a URL with a domain name that is routable by a domain name server to a designated network entity operated by an organization with which an operator of the payable content item server has an inter-organizational billing arrangement.

11-15. (canceled)

16. The storage medium defined in claim 1, wherein the social network server implements a social network service and wherein the e-commerce application is associated with a first member of the social network service and is rendered available to visiting members of the social network service including the user of the computing appliance.

17-34. (canceled)

35. A method comprising:
logging into a social network service using member credentials;
accessing a profile page of an other member of the social network service;
triggering instantiation of an e-commerce application represented on the profile page of said other member of the social network service;
viewing through the e-commerce application a set of preview items associated with payable content items offered for sale by said other member of the social network service;
selecting via the e-commerce application one of the preview items associated with a desired payable content item; and
receiving a location element for the desired payable content item.

36-41. (canceled)

42. The method defined in claim 35, wherein the preview items are stored on a payable content management server, wherein the method is executed by a computing appliance that connects to the social network service over the internet using an account established with a service provider, wherein the service provider has an inter-organizational billing arrangement with an operator of the payable content management server and wherein the location element for the desired payable content item comprises an address of a designated network entity operated by the service provider, the method further comprising:
accessing the designated network entity based on its address;
providing an authorization to charge a price of the desired payable content item to said account; and
receiving the payable content item.

43. The method defined in claim 42, further comprising:
viewing through the e-commerce application prices of the payable content items, including the price of the desired payable content item.

44. The method defined in claim 43, further comprising:
being charged an amount related to the price of the desired payable content item.

45-72. (canceled)

73. A non-transitory computer-readable storage medium storing computer-readable instructions for execution by a server, wherein execution of the instructions causes the server to implement a method that comprises:
displaying via a graphical user interface a profile page of a particular member of a social network service, the profile page maintaining information about the particular member accessible to other members of the social network service, wherein the information maintained on the profile page of the particular member includes an actionable link;
responding to actioning of said link by a visiting member of the social network service by:
establishing a connection to a payable content management server that stores a set of preview items corresponding to payable content items and a location element for each payable content item;
rendering the preview items accessible to the visiting member;
receiving an indication that a particular one of the preview items has been selected by the visiting member; and
forwarding to the visiting member the location element for the payable content item corresponding to the selected preview item.

74-104. (canceled)

105. A non-transitory computer-readable storage medium storing computer-readable instructions for execution by a server, wherein execution of the instructions causes the server to implement a method that comprises:
authorizing a user of a computing appliance to access a social network service based upon credentials of a member of the social network service;
receiving from the computing appliance a payable content item, a preview item corresponding to the payable content item and a price at which the payable content item is to be sold to other members of the social network;
establishing a connection to a payable content management server; and
providing to the payable content management server the payable content item, the preview item, the price and an identification of an account maintained by the payable content management server.

106. The storage medium defined in claim 105, wherein the method further comprises receiving from the computing appliance a price at which the payable content item is to be sold to other members of the social network and providing said price to the payable content management server.

107. The storage medium defined in claim 105, wherein the method further comprises receiving from the computing appliance a minimum bid at which the payable content item is to be sold at auction to other members of the social network and providing said minimum bid to the payable content management server.

108. The storage medium defined in claim 105, wherein the method further comprises binding the member of the social network to the account maintained by the payable content management server.

109. The storage medium defined in claim 105, wherein the method further comprises submitting account credentials to the payable content management server for authentication.

110. The storage medium defined in claim 109, wherein the method further comprises receiving an indication of whether the account credentials have been successfully authenticated by the payable content management server and wherein said providing is carried out only if the credentials have been successfully authenticated by the payable content management server.

111. The storage medium defined in claim 109, wherein the method further comprises receiving the account credentials from the computing appliance prior to submitting them to the payable content management server.

112-115. (canceled)

116. The storage medium defined in claim 105, wherein the method further comprises updating a profile of said member to indicate that the payable content item is for sale.

117. The storage medium defined in claim 105, wherein the method further comprises alerting one or more contacts on a contact list that the payable item is for sale.

118. The storage medium defined in claim 117, wherein the method further comprises sending a message to the one or more contacts to alert the one or more contacts that the payable item is for sale.

119. The storage medium defined in claim 105, the instructions being first instructions, wherein the first instructions are executed as part of administration tool of an e-commerce application rendered accessible via a profile of said member.

120. The storage medium defined in claim 119, further storing second computer-readable instructions for execution by the server, wherein execution of the second computer-readable instructions causes the server to implement a second method that comprises:
receiving an indication that a visiting member has accessed the e-commerce application;
establishing a connection to the payable content management server;
rendering the preview item accessible to a computing appliance connected used by the visiting member;
receive an indication that the preview item has been selected by the visiting member; and
forward to the visiting member's computing appliance a location element for the payable content item.

121. The storage medium defined in claim 120, wherein the second method further comprises determining the location element for the payable content item.

122-162. (canceled)

163. A payable content item server, comprising:
an input for receiving from a server associated with a social network service (i) an indication of a member of the social network service; (ii) a payable content item and (iii) a preview item corresponding to the payable content item;
an output for releasing the payable content item to towards a remote location attributed to the member;
a memory for storing, in association with the member, the preview item and a location element for the payable content item.

164. The server defined in claim 163, further comprising a processing entity for determining the location element for the payable content item.

165. The server defined in claim 163, wherein the location element for the payable content item comprises an address of a designated network entity operated by an organization with which an entity executing the method has an inter-organizational billing arrangement.

166-174. (canceled)

175. A method, comprising:
maintaining in a directory associated with a first user of a social network service (i) a preview item corresponding to a payable content item stored on a payable content item server and (ii) a location element for the payable content item, the preview item being displayable to other users of the social network service when the other users activate an e-commerce application via a social network profile of the first user;
collecting bids on the payable content item from a plurality of bidders who are other users of the social network service;
determining a winning bid and a winning bidder;
transmitting said location element to the winning bidder.

176. The method defined in claim 175, further comprising:
transmitting to the payable content item server a price to be associated with the payable content item.

177. The method defined in claim 176, further comprising:
calculating the price based on the winning bid.

178. The method defined in claim 177, wherein the price is higher than the winning bid and includes a commission for an entity that executes the method.

179-180. (canceled)

181. The method defined in claim 175, further comprising announcing a bidding time frame via the social network profile of the user and wherein determining a winning bid only includes consideration of bids received within the bidding time frame.

182-189. (canceled)
